(19) United States
(12) Patent Application Publication
(10) Pub. No.: US 2004/0167772 A1
(43) Pub. Date: Aug. 26, 2004

(54) Speech coding and decoding in a voice communication system

(76) Inventor: Engin Erzin, Istanbul (TR)

Correspondence Address: HARNESS, DICKEY & PIERCE, P.L.C., P.O. Box 8910, Reston, VA, 20195, US

(21) Appl. No.: 10/372,787

(22) Filed: Feb. 26, 2003

(51) Int. Cl. G10L 11/04

(52) U.S. Cl. 704/207

(57) ABSTRACT

A speech encoder, decoder, system, method, and machine-readable software which determine whether to enhance the quantization of speech modeling information depending on the change of one or more identified parameters. An encoder outputs a base quantization value that represents a communication signal information quantized at a base quantization level or sends an enhanced quantization value that represents communitcation signal information quantization level higher than the base quantization level.

### BACKGROUND OF THE INVENTION

1. Technical Field

The present invention relates generally to speech encoding and decoding in voice communication systems; and, more particularly, to a technique used with long-term linear prediction to obtain high quality speech reproduction through a limited bit rate communication channel.

2. Related Art

Signal modeling and parameter estimation play significant roles in communicating voice information with limited bandwidth constraints. To model basic speech sounds, speech signals are sampled as a discrete waveform to be digitally processed. In one type of signal coding technique called LPC (linear predictive coding), the signal value at any particular time index is modeled as a linear function of previous values. A subsequent signal is thus linearly predictable according to an earlier value. As a result, efficient signal representations can be determined by estimating and applying certain prediction parameters to represent the signal.

Applying LPC techniques, a conventional source encoder operates on speech signals to extract modeling and parameter information for communication to a conventional source decoder via a communication channel. Once received, the decoder attempts to reconstruct a counterpart signal for playback that sounds to a human ear like the original speech.

Where the channel bandwidth is shared and real-time reconstruction is necessary, a reduction in the required bandwidth proves beneficial. However, using conventional modeling techniques alone, the quality requirements in the reproduced speech limit the reduction of such bandwidth below certain levels. Further, the lower the bandwidth used for communications, the lower the quantization that modeling may be subject to if digitized and transmitted to a decoder. Typically, the higher the quantization, the higher the audible speech quality.

Communication packets of associated speech modeling signals are a means to transfer speech modeling information over a communication channel between endpoints. Communication packets may include several subframes, each subframe including modeling data and parameter data such as change in pitch lag (Pd) and pitch gain (Ga) information. In conventional systems, a fixed amount of communication channel bandwidth is required to communicate the modeling and parameter information such as Pd and Ga information to the decoder. The amount of quantization that may be applied to modeling data is in part determined by the number of bits allocated to the modeling data in each communication packet subframe.

With long-term linear predictive systems such as Code Excited Linear Prediction (CELP) speech coders, bandwidth constraints and fixed bit allocations for modeling data and Pd and Ga information, provide audible speech quality limitations.

### SUMMARY OF THE INVENTION

In an exemplary embodiment, the invention is directed to a method for improving the quality of a communication signal by encoding and/or decoding. More specifically, the method may include determining a change in pitch lag and a pitch gain of the communication signal and transmitting a base quantization value that represents communication signal information quantized at a base quantization level, if the change in pitch lag is large and the pitch gain is weak. The method may further include transmitting an enhanced quantization value that represents communication signal information quantized at a quantization level higher than the base quantization level, if the change in pitch lag is small and the pitch gain is strong. The method may further include receiving the change in the pitch lag and the pitch gain information when the change in the pitch lag is large and the pitch gain is weak. In addition, the method includes receiving the base quantization value when the change in pitch lag and pitch gain information are received. The method may further include receiving the enhanced quantization value when none of the change in pitch lag and pitch gain are received. The method may further include transmitting an enhanced quantization value when a spoken vowel is transmitted. The method may further include transmitting an enhanced quantization value if pitch periodicity and pitch gain are steady.

Other aspects, advantages and novel features of the present invention will become apparent from the following detailed description of the invention when considered in conjunction with the accompanying drawings.

### BRIEF DESCRIPTION OF THE DRAWINGS

FIG. 1 is an exemplary block diagram of a linear prediction encoder according to an exemplary embodiment of the invention; and

FIG. 2 is an exemplary block diagram of a linear prediction decoder according to an exemplary embodiment of the invention.

### DETAILED DESCRIPTION OF EXEMPLARY EMBODIMENTS

Additional features and advantages of the invention will be more fully apparent from the following detailed description of example embodiments, the appended claims and the accompanying drawings.

An exemplary embodiment of the present invention improves speech quality in decreased bandwidth communication systems by increasing quantization of speech modeling information in a communication subframe when long-term linear predictive redundancy parameters delta pitch or change in pitch lag (Pd) is almost zero and pitch gain (Ga) is close to unity.

Parts of a speech signal are periodic such as those that correspond to vowels. Some parts of a speech signal do not have any periodicity such as those that correspond to consonants. In a periodic region, the pitch period is generally stable. That is, the pitch period is strong and steady. Steady because pitch does not change much and strong because Ga is around one. Ga is generally limited to between zero and 1.2 or 1.3 and is normally, if pitch gain is steady, around one. The Ga and Pd can be observed when a speech signal is passed through a long-term linear prediction filter.

Linear Prediction (LP) may be used for modeling speech signals in telecommunication systems. LP filters may be used in tandem as a short-term LP filter and a long-term LP. Short-term LP filters are used to remove short-term redundancies in a speech signal and to model human vocal characteristics. Short-term filters in communication systems, typically, filter a 20 millisecond frame. Each 20 msec frame may be further compartmentalized into 4-5 msec subframes. Long-term LP filtering is performed, typically after short-term LP filtering, based on the periodicity of the speech signal to remove long-term redundancies. Long-term LP filters generally act on 4-5 msec subframes. After the long-term redundancies have been removed, the resultant speech modeling residual is quantized in some way, such as with a fixed codebook as in code excited linear prediction (CELP) speech coding.

An exemplary embodiment of the present invention is directed to a long-term LP system which performs pitch prediction along a smooth pitch contour. In general, the pitch prediction is performed for every 4-5 msec window (subframe) of speech signal and has high gains for active voice segments of the speech signal with pitch periodicity. A pitch period is extracted for every 20 msec (frame) of speech window and then a fine search is performed for pitch prediction for every 4-5 msec (subframe) over an interpolated pitch contour. The pitch prediction extracts a pitch gain, Ga, and a delta pitch, Pd, of an incoming speech signal. The pitch lag is generally delta quantized along the interpolated pitch contour.

For a strong voice speech segment and a good pitch contour, the parameters Ga and Pd that are sent to a receiver for pitch prediction become redundant. An entropy based coding for these parameters can unnecessarily use bandwidth that could be used for residual quantization of strong voiced segments.

Histograms of Pd and Ga parameters among subframes of active speech communications show maximization occurring when Pd is zero and Ga is close to unity. In histogram studies where a (Pd, Ga) pair is addressed with 5 bits (32 levels), the target (Pd=0, Ga>=0.95) pair occurred 15% of the time. This statistic, collected over a large speech database, also includes noisy background conditions with a transform predictive wideband speech coder (TPC).

In an exemplary embodiment of the present invention, a classification parameter may be placed in every communication subframe and encoded with the pitch prediction parameters depending on this classification parameter. The parameter may be a one bit strong voiced flag, Vs, which is used to control pitch prediction quantization. When the target (Pd=0, Ga>=0.95) pair occurs, the Vs flag is set (e.g. Vs=1) and pitch prediction parameters are not sent through a communication channel to the receiver. By not sending (Pd,Ga) pair information, typically 5 bits, extra bandwidth becomes available for use in quantizing residual of a significant time for active speech frames.

According to an exemplary embodiment of the present invention, bits allocated for the Ga and Pd parameters are reallocated to the modeling residual when (Pd=0, Ga>=0.95), thereby enhancing modeling residual bandwidth and enabling increased quantization of the modeling residual signal. This may slow down the update of long-term prediction filter parameters Pd and Ga where pitch gain is strong. Extra bandwidth for residual usually means better quality for speech, especially when it occurs in active voiced segments. The above described technique can be used in speech coding structures which uses long-term linear prediction to enhance audible speech quality. When (Pd=0, Ga>=0.95) is not true, the Pd and Ga parameters are passed to the receiver in each subframe.

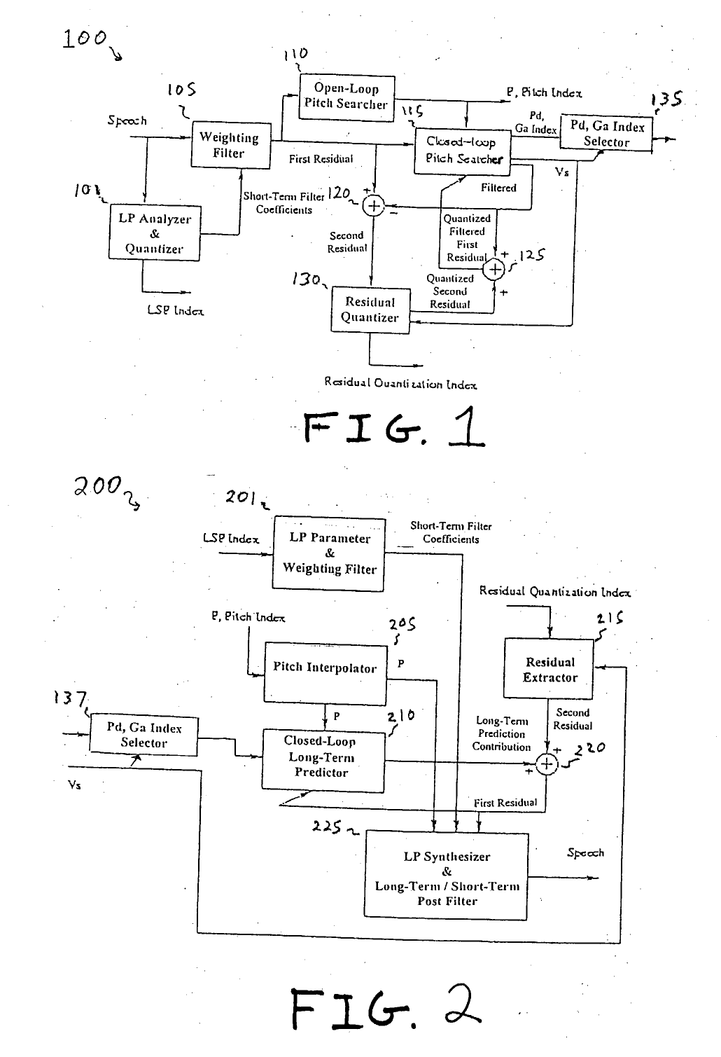

FIG. 1 is an exemplary block diagram of a linear prediction (LP) encoder 100 according to an exemplary embodiment of the present invention. The LP encoder 100 may be included as part of a transmitting system, such as a mobile handset or base station, that packages encoder output into frames and subframes. The description of system 100 is provided to aid in the general understanding of the LP encoder 100 and to provide a greater understanding of aspects of the present invention. The LP encoder 100 includes an LP Analyzer and Quantizer 101; Weighting Filter 105; Open-Loop Pitch Searcher 110; Closed-Loop Pitch Searcher 115; Adder 120; Adder 125, Residual Quantizer 130; and Pd, Ga Index Selector 135.

The LP encoder 100 receives a speech signal and outputs communication parameters such as pitch period (P), pitch index, change in pitch lag (Pd), pitch gain (Ga) index, residual quantization index, and linear spectral pair (LSP) index to be packaged in one of a communication frame or subframe and sent to a receiver that uses LP decoder 200 for decoding, illustrated in FIG. 2.

The LP Analyser and Quantizer 101 receives the digital voice signal and creates the LSP index and short-term LP filter coefficients. The short-term LP filter coefficients are output to the Weighting Filter 105. The LSP index value is incorporated into a frame and sent to the receiver for decoding.

The Weighting Filter 105 receives the short-term LP filter coefficients sent from the LP Analyser and Quantizer 101 and the speech signal and creates a first residual. The first residual is sent to the Open-Loop Pitch Searcher 110, Closed-Loop Pitch Searcher 115, and the Adder 120.

The Open-Loop Pitch Searcher 110 receives the first residual from the Weighting Filter 105 and generates an optimal Pitch Period (P) and Pitch Index which are incorporated into a communication frame sent to the receiver for decoding.

The Closed-Loop Pitch Searcher 115 receives the first residual and a quantized filtered first residual signal from Adder 125. In the Closed-Loop Pitch Searcher 115, each subframe is searched for a better resolution pitch near the optimal pitch period which is P, using a long-term prediction filter of the form 1/(1−Ga*Z^{-Pd}). As a result of this closed loop pitch search, signal errors are reduced. Pitch gain (Ga), change in pitch lag (Pd), and a filtered first residual are calculated and a Ga index assigned. The Closed-Loop Pitch Searcher 115 additionally generates a 1 bit strong voice (Vs) flag. When the target (Pd=0, Ga>=0.95) pair occurs, the Vs flag is set (e.g. Vs=1). When the target (Pd=0, Ga>=0.95) pair is not true, the Vs flag is not set (e.g. Vs=0). Outputs of the Closed-Loop Pitch Searcher 115 are the Ga index, Pd, a filtered first residual, and Vs. The filtered first residual is sent to Adders 120 and 125. Vs, Pd, and Ga index are output to a Pd, Ga Index Selector 135. Vs is additionally output to the Residual Quantizer 130.

At Adder 120, the filtered first residual is subtracted from the first residual. The resultant second residual is then sent to the Residual Quantizer 130.

The Residual Quantizer 130 receives the second residual from Adder 120 and Vs from the Closed-Loop Pitch Searcher 115 and calculates a quantized second residual. When the Vs flag is set (e.g. Vs=1), the Residual Quantizer 130, increases the quantization level of the second residual and assigns an enhanced quantization index value representing the quantized second residual information. Because of the increased quantization, the quantization index value bit length is typically increased by 5 bits. To fit the extra bits into the communication subframe associated with the set Vs flag, the bits (typically 5 bits) usually allocated for pitch prediction parameters (Pd, Ga), are used. By not sending (Pd, Ga) pair information, extra bandwidth becomes available for use in quantizing residual of a significant time for active speech frames. The quantized second residual is output to Adder 125 and the enhanced residual quantization index value is incorporated into a communication frame sent to the receiver for decoding.

When the Vs flag is not set (e.g., Vs=0), the Residual Quantizer 130 calculates a base quantization index value of normal bit length. The quantized second residual is then output to Adder 125 and the base residual quantization index value is incorporated into a communication frame sent to the receiver for decoding.

At Adder 125, the long-term prediction components are added to the quantized second residual. Adder 125 then outputs a quantized first residual filter signal to the Closed-Loop Pitch Searcher 115.

The Pd, Ga Index Selector 135 receives the Pd, Ga, and Vs from the Closed-Loop Pitch Searcher 115. If Vs is not set, the Pd and Ga information are encoded, and Vs information are incorporated into a frame and sent to the receiver for decoding. If Vs is set, Vs without the Pd and Ga information is incorporated into a frame and sent to the receiver for decoding. In an alternative, the Pd and Ga information is not encoded.

FIG. 2 is an exemplary block diagram of a linear prediction (LP) decoder 200 according to an exemplary embodiment of the present invention. The LP decoder 200 may be included as part of a receiving system, such as a mobile handheld device or base station, that receives and unpacks LP encoder 100 output. The description of system 200 is provided to aid in the general understanding of the LP decoder 200 and to provide a greater understanding of exemplary embodiments of the present invention. The LP decoder 200 includes a Pd, Ga Index Selector 137, LP Parameter and Weighting Filter 201, Pitch Interpolator 205, Closed-Loop Long-Term Predictor 210, Residual Extractor 215, Adder 220, and LP Synthesizer and Long-Term/Short-Term Post Filter 225.

The LP decoder 200 receives the LSP index, pitch period (P), pitch index, change in pitch lag (Pd), pitch gain (Ga) index, residual quantization index, and strong voice (Vs) flag from a transmitter using the LP encoder 100, illustrated in FIG. 1, for encoding in one of a communication frame or subframe and produces a speech signal.

The Pd, Ga Index Selector 137 receives from a communication subframe sent from the transmitter Vs, Pd, and Ga information and decodes it. If the Vs flag is not set, the Pd and Ga information is passed to the Closed-Loop Long-Term Predictor 210. If the Vs flag is set, the Pd, Ga Index Selector 137 does not send an updated Pd or Ga value to the Closed-Loop Long-Term Predictor 210. Alternatively, preset values (e.g., Pd=0, Ga=0.95) may be sent from the Pd, Ga Index Selector 137 to the Closed-Loop Long-Term Predictor 210. In still another alternative, the Closed-Loop Long-Term Predictor 210 may use preset values.

The LP Parameter and Weighting Filter 201 receives the LSP index from the transmitter and extracts LP parameters out of the LSP index to create short-term filter coefficients. Short-term filter coefficients output to the LP Synthesizer & LongTerm/Short-Term Post Filter 225.

The Pitch Interpolator 205 receives the pitch period (P) and pitch index from the transmitter and outputs a base pitch period (P) for each subframe to the LP Synthesizer & Long-Term/Short-Term Post Filter 225 and the Closed-Loop, Long-Term Predictor 210.

The Closed-Loop Long-Term Predictor 210 receives the Pd and Ga Index from the transmitter, the base pitch period (P) for each subframe, and the first residual from the Adder 220 and outputs a long-term prediction contribution to the Adder 220.

The Residual Extractor 215 receives the Vs flag from the transmitter. If the Vs flag is not set, the Residual Extractor 215 extracts the base residual quantization index value from the communication frame sent from the transmitter. If the Vs flag is set, the Residual Extractor 215 extracts an enhanced residual quantization index value from the communication frame sent from the transmitter that includes more bits (typically 5 more bits) than the base residual quantization index value. Using an enhanced residual quantization index value, the Residual Extractor 215 renders a second residual of greater precision which eventually translates to better speech quality for a particular communication subframe. Regardless of the Vs value, the second residual is output to Adder 220.

Adder 220, receives the long term prediction contribution from the Closed-Loop Long-Term Predictor 225 and the second residual from the Residual Extractor 215 and outputs to the Closed-Loop Long-Term Predictor 210 and the LP Synthesizer & Long-Term/Short-Term Post Filter 225 the first residual.

The LP Synthesizor and Long-Term/Short-Term Post Filter 225 receives short-term filter coefficients from the LP Parameter and Weighting Filter 201, base pitch period for each subframe from the Pitch Interpolator 205 and the first residual from the Adder 220 and outputs a speech signal.

The above exemplary embodiments describe Ga and Pd parameters for bit replacement and setting the Vs flag that optimize a histogram ˜15% of the time. That is Pd=0 and Ga>=0.95 approximately 15% of the time for normal speech activity. The 15% occurrence is an important number for active speech segments since increasing the quantization for 15% of a communication on average yields improved sound quality. Similar improvements in sound quality are obtainable where the Pd is significantly close to zero (Pd is small) and Ga is greater than or significantly close to 0.95 (Ga is strong).

Sound quality may be improved because bits, normally allocated to Pd and Ga values when Pd is small and Ga is strong, are reallocated to allow a greater quantization of the communication signal. This may not be the case when the Pd is significantly greater than nil (Pd is large) or Ga is significantly less than 0.95 (Ga is weak).

Where Pd is large or Ga is weak, using a fixed value for the large Pd and weak Ga at the decoder to make up for their replacement at the encoder with enhanced quantization bits, may result in fixed Pd and Ga values at the decoder significantly too inaccurate to maintain or improve signal quality when decoding.

In another exemplary embodiment of the present invention, spoken vowels may possess a quality that Pd is small and Ga is strong. In this context, spoken vowel sounds may be sounds associated with spoken vowels, sounds with spoken vowel pitch characteristics, or background noises or other sounds where Pd is small and Ga is strong. This being said, if spoken vowel sounds are encoded, bit replacement, as described above when Pd is small and Ga is strong, may be performed to obtain an enhanced quantization level and improved signal quality. Further, when spoken vowel sounds are not being communicated (i.e., sounds similar to consonants used in human speech), a base quantization level may be used.

In still another exemplary embodiment of the present invention, where Pd is small and Ga is strong, the pitch periodicity and pitch gain are relatively steady. This being said, when pitch periodicity and pitch gain are steady, bit replacement, as described above when Pd is small and Ga is strong, may also be performed to obtain improved signal quality. Further, when pitch periodicity or pitch gain are not relatively steady, a base quantization level may be used.

Although the above exemplary embodiments describe Vs as one bit and the enhanced residual quantization index is described as being expanded by 5 bits, advantages may also be obtained by varying the respective bit sizes so that the total number of bits for Vs and the number of bits added to obtain the enhanced quantization index value is no greater than the total number of bits used for the Pd and Ga parameters packaged in a subframe. For example, the Pd and Ga parameters may use 5 bits in a subframe. In this case, Vs may be 1 bit and the enhanced quantization index value may be increased by 4 bits for a total of 5 bits. In such a case, frame size need not be changed to accommodate the Vs bit. Similar advantages may be obtained for Vs being 2 bits and the enhanced quantization index value being increased by 3 and so on.

Other implementations may obtain similar quality enhancements by using similar bit replacement techniques but using different combinations of Pd and Ga replacement. For example, the Vs flag may be more than one bit and indicate that only the Pd bits are replaced, only Ga bits are replaced, both Ga and Pd bits are replaced, or both Ga and Pd bits have not been replaced.

Although the exemplary embodiments of the present invention described above have been described as making the determination as to whether to set the Vs flag based on the Pd and Ga parameters, the decision to set the Vs flag could be made on either of these parameters alone. Still further, in exemplary embodiments of the present invention, other communication parameters could also be used, as described above, either in combination with or separate from the Pd and Ga parameters.

Still further, although the exemplary embodiments of the present invention have been described above in conjunction with a linear predictive coding, various features of the present invention may also be utilized in other encoder/decoders, as would be known to one of ordinary skill in the art. Moreover, exemplary embodiments of the present invention may be used between handset and handset, handset and base station, and base station and base station.

Still further, although the exemplary embodiments described above in connection with the present invention are particularly useful in CDMA systems, they may also be utilized in any other communication system, as would be known to one of ordinary skill in the art.

It is noted that the functional blocks in the exemplary embodiments of FIGS. 1 and 2 may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations. The computer executable program(s) may also be provided as part of externally supplied propagated signal(s) either with or without carrier wave(s).

This specification describes various exemplary embodiments of the method and system of the present invention. The scope of the claims are intended to cover various modifications and equivalent arrangements of the illustrative embodiments disclosed in this specification. Therefore, the following claims should be accorded the reasonably broadest interpretations to cover modifications, equivalent structures in features which are consistent with the spirit and the scope of the invention disclosed herein.

What is claimed is:

1. A method for encoding a communication signal comprising at least one of:
encoding the communication signal at a base quantization level only if the communication signal represents sounds that sound different than spoken vowels; and
encoding the communication signal at an enhanced quantization level, the enhanced quantization level being higher than the base quantization level.

2. The method of claim 1, wherein the encoding is executed by a device that is at least one of a handset and a base station.

3. The method of claim 1, further comprising:
replacing bits allocated to pitch gain and change in pitch lag information with enhanced quantization value bits, if encoding the communication signal at an enhanced quantization level.

4. A method for decoding a communication signal comprising:
decoding the communication signal at a base quantization level only if the communication signal represents sounds that sound different than spoken vowels; and
decoding the communication signal at an enhanced quantization level, the enhanced quantization level being higher than the base quantization level.

5. The method of claim 4, wherein the encoding is executed by a device that is at least one of a handset and a base station.

6. The method of claim 4, further comprising:
receiving a flag indicating contents of a pitch gain and change in a pitch lag information field.

7. A method for encoding a communication signal comprising:
encoding the communication signal at a base quantization level if the communication signal represents sounds with a pitch periodicity that is unsteady or a pitch gain that is unsteady; and
encoding the communication signal at an enhanced quantization level if the communication signal represents sounds with a steady pitch periodicity and a steady pitch gain, the enhanced quantization level being higher than the base quantization level.

8. The method of claim 7, wherein the encoding is executed by a device that is at least one of a handset and a base station.

9. A method for decoding a communication signal comprising:
decoding the communication signal at a base quantization level if the communication signal represents sounds with a pitch periodicity that is unsteady or a pitch gain that is unsteady; and
decoding the communication signal at an enhanced quantization level if the communication signal represents sounds with a steady pitch periodicity and a steady pitch gain, the enhanced quantization level being higher than the base quantization level.

10. The method of claim 9, wherein the encoding is executed by a device that is at least one of a handset and a base station.

11. A method for communicating a communication signal comprising:
encoding the communication signal including
determining a change in pitch lag and a pitch gain of the communication signal,
encoding the communication signal at a base quantization level only if the communication signal represents sounds that sound different than spoken vowels; and
encoding the communication signal at an enhanced quantization level, the enhanced quantization level being higher than the base quantization level, and
decoding the communication signal including:
decoding the communication signal at a base quantization level only if the communication signal represents sounds that sound different than spoken vowels; and
decoding the communication signal at an enhanced quantization level, the enhanced quantization level being higher than the base quantization level.

12. The method of claim 11, wherein the encoding is executed by a first device and the decoding is executed by a second device, the first device being at least one of a first handset and a first base station, and the second device being at least one of a second handset and a second base station.

13. A method for communicating a communication signal comprising:
encoding the communication signal including
determining a change in pitch lag and a pitch gain of the communication signal,
encoding the communication signal at a base quantization level if the communication signal represents sounds with a pitch periodicity that is unsteady or a pitch gain that is unsteady; and
encoding the communication signal at an enhanced quantization level if the communication signal represents sounds with a pitch periodicity that is steady and a pitch gain that is steady, the enhanced quantization level being higher than the base quantization level, and
decoding the communication signal including
decoding the communication signal at a base quantization level if the communication signal represents sounds with a pitch periodicity that is unsteady or a pitch gain that is unsteady; and
decoding the communication signal at an enhanced quantization level if the communication signal represents sounds with a pitch periodicity that is steady and a pitch gain that is steady, the enhanced quantization level being higher than the base quantization level.

14. The method of claim 13, wherein the encoding is executed by a first device and the decoding is executed by a second device, the first device being at least one of a first handset and a first base station, and the second device being at least one of a second handset and a second base station.

15. A method for speech encoding comprising:
determining a change in pitch lag and a pitch gain of the speech signal;
transmitting a base quantization value that represents speech signal information quantized at a base quantization level, if the change in pitch lag is significantly greater than zero or the pitch gain is significantly less than 0.95; and
transmitting an enhanced quantization value that represents speech signal information quantized at a quantization level higher than the base quantization level, if the change in pitch lag is significantly close to zero and the pitch gain is greater than or significantly close to 0.95.

16. The method of claim 15, wherein the determining and transmitting are executed by at least one of a handset and a base station.

17. A method for speech decoding comprising:
receiving change in pitch lag and pitch gain information if the change in pitch lag is significantly greater than zero or the pitch gain is significantly less than 0.95;
receiving a base quantization value that represents speech signal information quantized at a base quantization level if the change in pitch lag and pitch gain information are received; and
receiving an enhanced quantization value that represents speech signal information quantized at a level higher than the base quantization level if none of the change in pitch lag and pitch gain information are received.

18. The method of claim 17, wherein the receiving is executed by at least one of a handset and a base station.

19. A method for communicating a speech signal comprising:
encoding the speech signal including
determining a change in pitch lag and a pitch gain of the speech signal,
transmitting a base quantization value that represents speech signal information quantized at a base quantization level, if the change in pitch lag is significantly greater than zero or the pitch gain is significantly less than 0.95, and
transmitting an enhanced quantization value that represents speech signal information quantized at a quantization level higher than the base quantization level, if the change in pitch lag is significantly close to zero and the pitch gain is greater than or significantly close to 0.95; and
decoding the speech signal by a method including
receiving the change in the pitch lag and the pitch gain information if the change in the pitch lag is significantly greater than zero and the pitch gain is significantly less than 0.95,
receiving the base quantization value if the change in pitch lag and pitch gain information are received, and
receiving the enhanced quantization value if none of the change in pitch lag and pitch gain are received.

20. The method of claim 19, wherein the encoding is executed by a first device and the decoding is executed by a second device, the first device being at least one of a first handset and a first base station, and the second device being at least one of a second handset and a second base station.
